(19) United States
(12) Patent Application Publication
(10) Pub. No.: US 2008/0162093 A1
(43) Pub. Date: Jul. 3, 2008

(54) Method of constructing a geological model of a subsoil formation constrained by seismic data

(76) Inventors: Philippe Nivlet, Paris (FR); Nathalie Lucet, Houilles (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/000,246

(22) Filed: Dec. 11, 2007

(30) Foreign Application Priority Data
Nov. 12, 2006 (FR) 06/10.792

(51) Int. Cl. G06F 17/11; G06G 7/48

(52) U.S. Cl. 703/2; 703/6

(57) ABSTRACT

An method of constructing a geological model of a subsoil formation constrained by seismic data having application to petroleum reservoir development is disclosed. Logs relative to geological properties are acquired and a seismic facies cube is constructed. Logs relative to geological properties and logs relative to seismic facies are then simulated. Then distribution of proportions is estimated at any point on the subsoil by means of the acquired logs in the well and of the simulated logs. A seismic constraint is then defined by constructing a lithologic facies average proportion cube from these estimated proportion distributions. Finally, a geological model wherein the geological properties are constrained by this lithologic facies average proportion cube is constructed.

### BACKGROUND OF THE INVENTION

1. Field of the Invention

The present invention relates to a method for constructing a three-dimensional geological model representative of the structure of a subsoil formation constrained by seismic data.

The method provides engineers with a mechanism to best develop reserves of a petroleum reservoir.

2. Description of the Prior Art

Optimization and development of petroleum reservoirs is based on as accurate as possible a description of structure and petrophysical properties of the studied reservoir. Specialists therefore use a tool accounting for these two aspects in an approximate way which is a geological model. A geological model is thus intended to best account for the structure and the petrophysical properties of a reservoir. The model therefore includes: a grid pattern forming a frame of the reservoir and that has to be representative of the structure, and three-dimensional petrophysical property maps associated with the grid, that have to be representative of the static or dynamic behaviour of the reservoir. This association assigns a petrophysical value obtained from 3D maps to each grid cell.

A three-dimensional petrophysical property map provides a three-dimensional realistic representation of the subsoil heterogeneities. These petrophysical properties, in the general sense, can be for example the rock type (sandstone, sand, limestone, . . . ), the type of porosity encountered (porous/low-porosity rock), or any other type of discrete property.

Conventionally, these 3D maps are obtained from stochastic methods based on geostatistical simulation methods. These techniques are commonly used in this context for the following reasons:
These techniques can be constrained by certain data such as, for example, well data (core samples, or lithofacies interpreted from measured logs);
These techniques can adapt to a complex geometry by following a complex subsoil grid pattern (derived for example from a prior stratigraphic analysis);
These techniques reproduce global characteristics of the distributions of the property (proportions of the various lithologic facies for example);
These techniques reproduce a model of spatial variability of these properties (variogram) and thus provide realistic subsoil images as regards this variability;
These techniques can integrate indirect information on the geology so as to better estimate the lateral variations of heterogeneities, by dealing if necessary with the problem of making (direct and indirect) information whose measuring support and resolution can be very different compatible; and
These techniques can provide many equally probable realizations of the underground formation studied and therefore allow to estimate the uncertainties linked with modelling.

In a stochastic context, the expression realization is used rather than numerical model. The quality of the development of a petroleum reservoir thus directly depends on the accuracy of these stochastic realizations (3D petrophysical property maps). It is therefore advisable to work out stochastic realizations and therefore, more generally, geological models that are as coherent as possible with all the data collected (well, laboratory, . . . ), and notably seismic data.

Before discussion of the state of the art, clarification is necessary of two fundamental notions in the integration of seismic data during geological modelling: lithologic facies and seismic facies.

A lithologic facies (lithofacies) qualifies a property of a rock. For example, the lithologic facies can refer to the geological nature of the rock (clay, sandstone, limestone, . . . ), to its porosity type (unconsolidated and very porous rock; low-porosity rock, . . . ), to the nature of the fluid trapped in the pores (brine, oil, gas, . . . ). The spatial variability of the lithologic facies is characterized on a fine scale (some centimeters). The various lithologic facies are generally defined in a subsoil coring description, but they can also result from an interpretation of logs recorded in wells.

A seismic facies is defined from seismic data; it expresses a local homogeneity of the seismic information. It can take a finite number of values. A seismic facies can be defined in a two-dimensional map, in which case it characterizes the information provided by seismic trace portions extracted on a reservoir interval. It can also be defined in a three-dimensional volume representing the subsoil, in which case it characterizes the information provided by seismic voxels (local neighbourhoods) having similar characteristics. The mathematical relation between the seismic information and the seismic facies, calibrated during analysis, is referred to as classification function.

Construction of a Geological Model Constrained by Secondary Data

Many techniques allowing construction of a geological model constrained by seismic data are known to specialists. A non-stationary modelling technique called thresholded Gaussian simulation can be mentioned by way of example. This technique is described in the following document:
Le Loc'h G. and Galli A., 1997: Truncated Plurigaussian Method: Theoretical and Practical Points of View. In: Geostatistics Wollongong '96, E. Y. Baafi and N. A Schofield eds, Kluwer, p. 211-222.

Within the scope of this method, information referred to as “indirect” can be obtained from stratigraphic knowledge (large-scale spatial variations of the occurrence probability of a certain geological object for example), or derived from seismic data interpretations. In any case, this secondary information allows constraint of the spatial variation of the average proportions of each lithologic facies.

Secondary Data Determination

There are different known techniques, for determining these secondary data. An example thereof is the method described in the following document, which can be used by the thresholded Gaussian simulation method:
Doligez B., Fournier F., Jolivet G., Gancarski S.°, Beucher H., 2002: Seismic Facies Map Integration in Geostatistical Geological Model: a Field Case. EAGE, Conference & Technical Exhibition of European Association of Geoscientists & Engineers, 64th, Florence, 27-30 May 2002, Extended abstracts, Vol. 2, P215-219.

According to this method, an analysis of the shape of the seismic traces between two horizons, resulting from pickings on seismic data, allows calculation of a two-dimensional seismic facies map and its associated probability. The wells located in a homogeneous zone as regards the seismic facies allow calculation of a curve of the average vertical variations of lithologic facies proportions for this seismic facies. This curve is then applied to all the points of the 2D map assigned in this seismic facies, on condition that the associated probability takes a sufficiently high value. In the opposite case, the vertical variations of the lithologic facies proportions are re-estimated by interpolation of the other data, by kriging for example. At the end of the analysis, average probabilities of encountering the various instances of the lithologic facies are available at any point of the subsoil.

The major drawback of this type of approach is that the constraint results from a two-dimensional map interpretation. If the subsoil has a vertical complexity, it has to be divided into a large number of intervals, defined by picked horizons, and the seismic facies interpretations have to be multiplied for each one of these intervals The seismic facies interpretation quality greatly depends on the picking of horizon quality that is not always guaranteed, especially in a complex zone.

It is therefore necessary to directly extract three-dimensional information (seismic facies) from the seismic data, as described in the following document:
Barens L., Biver P., 2004: Reservoir Facies Prediction from Geostatistical Inverted Seismic Data, Abu Dhabi International Conference and Exhibition, 10-13 October, SPE 88690-MS.

This method allows description of the lithologic facies distributions by relating them directly to the lithologic facies proportion distributions by seismic facies (derived from wells) and to the seismic facies probabilities (derived from the seismic facies analysis). However, in this method distributions of the lithologic facies by seismic facies are spatially stationary. In practice, this condition is rarely met, which can create a significant bias in the estimation of the average lithologic facies proportions.

The method according to the invention allows direct extraction of three-dimensional secondary information from the seismic data, while accounting for the non-stationarity of the lithologic facies.

### SUMMARY OF THE INVENTION

The invention thus relates to a method of constructing a geological model of a subsoil formation constrained by seismic data, from logs relative to geological properties of the subsoil acquired in at least one well drilled through the subsoil, and wherein at least one seismic facies cube is constructed. The method comprises the following stages:
generating simulated geological logs corresponding to equally probable realizations of logs relative to geological properties, by carrying out an indicatrix sequential simulation from the logs acquired in the well;
generating simulated seismic facies logs corresponding to equally probable realizations of logs relative to the seismic facies, by interpreting the simulated geological logs;
constructing a lithologic facies proportion distribution cube comprising voxels with each voxel containing distribution of proportions of each lithologic facies by using the logs acquired in the at least one well, the simulated logs and the seismic facies cube;
constructing a lithologic facies average proportion cube comprising voxels with each voxel containing an estimation of a proportion of each lithologic facies contained in the voxel by extracting an average of lithologic facies proportion distribution at each voxel of the lithologic facies proportion distribution cube; and
constructing a geological model wherein the geological properties are constrained by the lithologic facies average proportion cube.

The simulated seismic facies logs can be generated by means of a relation between the seismic data and the seismic facies of the average proportion cube, the relation being obtained by a seismic facies analysis.

The lithologic facies average proportions can be estimated by carrying out the following stages:
estimating conditional distributions of lithologic facies proportions by seismic facies from the logs acquired in the well and the simulated geological and seismic facies logs;
determining classification probabilities for said seismic facies, as well as a relation between the seismic data and the seismic facies, by means of a seismic facies analysis; and
estimating at any point of the subsoil the lithologic facies proportions at any point of the subsoil, by combining the conditional distributions with the classification probabilities.

The simulated geological logs can comprise at least one of the following logs: a lithologic facies log, a P wave impedance log and a S wave impedance log.

The simulated logs can be generated in depth, then converted into time by means of a time-depth conversion law determined at the well.

The simulated logs converted to time can be resampled at the seismic data interval.

The simulated logs relative to lithologic facies can be resampled by determining a vertical proportion curve, by evaluating the frequency of appearance of the lithologic facies in a sliding time window whose size corresponds to the vertical resolution of the seismic data.

The simulated logs that are not relative to lithologic facies can be resampled by applying a low-pass frequency filter in order to eliminate the high frequencies that are not present in the seismic data.

Estimation of the lithologic facies proportion distributions can comprise using non-stationarity factors such as depth or shaliness.

It is possible to estimate an uncertainty on the lithologic facies proportion distributions estimated at any point of the subsoil.

The uncertainty can be estimated by calculating at least one of the following statistical parameters: a distribution standard deviation, an interquartile interval of the distributions, and a confidence interval on the distribution average.

### BRIEF DESCRIPTION OF THE DRAWINGS

Other features and advantages of the method according to the invention will be clear from reading the description hereafter of embodiments given by way of non limitative example, with reference to the accompanying figures wherein:

FIG. 1 shows logging data available at the level of a well;

FIG. 2 shows a probability map (PB) of a seismic facies extracted from a 3D cube along a reservoir level;

FIG. 3 shows ten equally probable realizations of the geological facies columns, simulated from the well data shown in FIG. 1;

FIG. 4 shows the corresponding ten realizations of the seismic facies interpretation from the simulated data of FIG. 3;

FIGS. 5A and 5B show the average proportion maps of the massive clays (AM) extracted along a reservoir level: in FIG. 5A, these proportions were obtained without the method according to the invention, in FIG. 5B these proportions were obtained with the method according to the invention; and

FIGS. 6A and 6B show the average proportion maps of the laminated clays (AL) extracted along a reservoir level: in FIG. 6A, these proportions were obtained without the method according to the invention, in FIG. 6B these proportions were obtained with the method according to the invention.

### DETAILED DESCRIPTION OF THE INVENTION

The method according to the invention allows construction of a three-dimensional geological model of a subsoil formation constrained by seismic data. The method mainly comprises the following stages:

1—Data acquisition and processing (ACQ)

2—Data simulations from the acquired data (SIM)

3—Construction of a seismic constraint for the geological model (SC)

4—Construction of the geological model constrained by the seismic constraint (GM).

1—Data Acquisition and Processing (ACQ)

The construction of the geological model according to the invention is based on two types of data:

Geological Data

These data are acquired in depth from measurements performed in wells, logs, or in the laboratory on rock samples such as cores. For each well, it is necessary to acquire the following logs:
logs necessary for seismic attribute calculations,
logs necessary for determination of a depth/time law,
lithologic facies logs, and
possible logs for completing the geological model.

The lithologic facies log associated with a well results from the interpretation of the other logs by means of known techniques known. These lithologic facies allow the subsoil to be described locally in terms of rock type (sandstone, sand, limestone, . . . ), porosity type encountered (unconsolidated and very porous rock, low-porosity rock, . . . ), and nature of the fluid trapped (brine, oil, gas). The spatial variability of these lithologic facies is characterized on a fine scale (some centimeters).

Seismic Data

These data are acquired in time from seismic surveys. These data are generally one or more seismic amplitude cubes processed according to known geophysical methods. Like a geological model, a seismic cube is a grid pattern and of associated 3D seismic amplitude maps. The grid pattern corresponds to a discretization of the soil into sub-volumes referred to as voxels, depending on the acquisition device, and allowing, via the associated 3D map, to assign to each one of these discretization volumes (voxels) the value of the seismic amplitudes recorded as a function of time.

One or more seismic attributes are then determined from these seismic data. These attributes are typically seismic measurements extracted from one or more seismic images of the subsoil, in a vicinity of a particular voxel of the subsoil. These attributes can be directly the amplitudes or they can result from the interpretation of measurements such as the seismic impedances of the P and/or S waves. The number of seismic attributes can be advantageously reduced by means of techniques such as main component analysis.

These seismic attributes are then interpreted by means of a seismic facies analysis technique which interprets the seismic data in terms of seismic facies, that is homogeneous data groups. Classification techniques (discriminant analysis for example) are therefore used to construct these seismic facies. This allows calculation of a classification function, that is a relation between the seismic attributes and the seismic facies. This seismic facies analysis can be supervised (calibrated classification function from a pre-existing database) or non-supervised. Such methods are for example described by:
Fournier F., Derain J-F., 1995: A Statistical Methodology for Deriving Reservoir Properties from Seismic, Geophysics, Vol. 60, No. 5, 1995, p. 1437-1450.

This method can be described within the scope of the seismic facies supervised analysis. The problem to be solved can be formalized as follows: consideration of seismic objects x(x₁, x₂, . . . , x_{N}) located in space and described by a set of seismic attributes xᵢ. Among the set of seismic objects, it is assumed that it is known how to interpret a certain number thereof in terms of seismic facies, these facies belonging to a predetermined list {C₁, . . . , C_{M}}. These particular objects make up the learning base. For example, at the level of a well, it is known to go, at a given point of the subsoil, across a gritty formation whereas lower in the same well, going across a clayey interval has occurred. The goal is to try to calibrate a probabilistic relation between the seismic objects and the list of the seismic facies by relying on the learning base. The discriminant analysis technique is therefore used, which allows calculation of each seismic object x a vector each of the M components of which denoted by P(x/Cⱼ^{l}) corresponding to the classification probability of the object in question in the class (seismic facies) Cⱼ. These probabilities can be related to other quantities by the Bayes rule:

$$P ( {C}_{j} / x ) = \frac{P ( x / {C}_{j} ) P ( {C}_{j} )}{{\sum }_{k = 1}^{M} P ( x / {C}_{k} ) P ( {C}_{k} )}$$

where terms P(x/Cₖ) are conditional probability density functions (at the seismic facies Cₖ), and the P(Cₖ) are the a priori probabilities of each seismic facies.

The a priori probabilities of each seismic facies are fixed by the user of the method. A common choice uses probabilities all equal to the same value 1/M.

The conditional probability density functions are estimated by means of the learning base information. They can be estimated assuming that they follow a multivariate Gaussian law (in which case the learning base is used to estimate the parameters of this law: average and variance-covariance matrix). They can also be estimated, if the size of the learning base allows, estimation by a non-parametric method, among which the kernel method, or the method of the K closest neighbors, which are known.

On this basis, the discriminant analysis comprises two stages:
a learning stage during which it is determined that the calibrated probabilistic relation is compatible with the learning base information and
a classification stage during which the previously calibrated classification function is used to estimate the probabilities of belonging to the seismic facies set, for all of the seismic objects measured on the subsoil.

Thus, the seismic facies analysis allows determination of:
a seismic facies cube;
a classification function;
a seismic facies classification probability cube.

### Acquisition Example

According to a particular embodiment example, the calculated seismic attributes are the seismic impedances of the P and S waves. The logs acquired are as follows:
logs necessary for the seismic attribute calculations and logs necessary for determination of a depth/time law: sonic log and density log. These two logs allow to calculation of the impedance logs P and S, and
possible logs for completing the geological model: porosity.

2—Data Simulation from Acquired Data (SIM)

Principle

The seismic constraint used by the method according to the invention is a lithologic facies average proportions cube, estimated from a seismic facies cube. What is referred to as “lithologic facies average proportions” is the estimation, at any discretization “point” of the subsoil, of the proportion of each lithologic facies contained in this discretization “point”. What is referred to as discretization “point” is a depth interval for the logs and a voxel for the 3D cubes.

Accounting for the geological non-stationarities when estimating these lithologic facies average proportions by seismic facies increases the number of degrees of freedom of the problem. Generally, the data allowing this estimation are limited (well data) and the statistical estimations resulting therefrom become unreliable.

To estimate these proportions while accounting for the non-stationarities, linked with the depth or with variations of other factors such as the shaliness or the average porosity of the rocks in place, the method allows artificially increasing the data used for estimation of the lithologic facies average proportions.

These new data are generated by an indicatrix sequential simulation technique (1D geostatistical simulation technique), which guarantees that the vertical variability of the new data reproduces that of the constraint well data (well used for the generation of new data). The increase in the number of data then allows to estimation more reliably of the lithologic facies average proportions by seismic facies, by accounting for the non-stationarities in this estimation.

The method according to the invention is therefore first based on the technique referred to as “pseudo-well” technique, described for example in the following documents:
de Groot, P. F. M., Bril, A. H., Floris, F. J. T., and Campbell, A. E., 1996, Monte Carlo Simulations of Wells, Geophysics, vol. 61, no. 3, p 631-638,
Gançarski, S., Valois, J. P., and Palus, C., 1994, The Pseudo-Well Technique: a Tool for Statistical Calibration of Seismic Data in a Field with Limited Well Control: 56th Mtg. and Techn. Exhib., Eur. Assoc. Expl. Geophys., PO55.

These techniques are based on Monte-Carlo or Markov Chain type simulations. The following document is referenced, whose method is based on purely geostatistical simulations, which allows accounting for the spatial variability of the data:
Joseph, C., F. Fournier, and Vernassa S., 1999, Pseudowell Methodology: A Guiding Tool for Lithoseismic Interpretation: 69th Annual International Meeting, SEG, Expanded Abstracts, 938-941.

The latter method allows generation of equally probable realizations of well data of high vertical resolution such as, for example, lithologic facies columns and the impedances of P and S waves. These realizations will be referred to as pseudologs hereafter, all of the pseudologs corresponding to a realization called pseudo-well. Pseudologs thus are simulated logs described as a function of depth. In order to implement this technique, it is necessary to carry out a multivariable statistical analysis of these parameters (lithologic facies and logs), as well as a variographic analysis allowing characterization of their vertical variations. This analysis is carried out from the data of a well and it is repeated for all of the available wells. The pseudo-well method is described precisely hereafter.

Pseudo-Well Method

Generation of a pseudo-well occurs, from real data acquired in a field or an outcrop, in simulating lithologic, petrophysical or other facies logs, selected according to the goal of the study. Limitation is hereafter to the case of simulation of a lithologic facies column and of a porosity log.

Lithologic Column Simulation
In order to simulate a lithologic facies column, the pseudo-well technique uses the well data available in an indicatrix sequential simulation algorithm (Fichtl P., Fournier F., Royer J-J., 1997, Cosimulations of Lithofacies and Associated Reservoir Properties Using Well and Seismic Data. SPE, Annual Technical Conference and Exhibition of the Society of Petroleum Engineers, 72nd, San Antonio, Oct. 5-8, 1997, Proceedings, Part I, pp. 381-393., SPE 38680). This method does not directly work on the lithologic facies but on the associated indicatrix functions, each one corresponding to a lithologic facies. These indicatrix functions Iᵢ(z) are equal to 1 if the lithologic facies Lᵢ is present at depth z, otherwise 0.

The input data of the indicatrix simulation technique are:
the proportions pᵢ of the various lithofacies Lᵢ at each depth point z to be simulated that give average geology variations and allow performing non-stationary simulations;
modelled variograms of the indicatrix functions that synthesize the information on the vertical variability of the lithologies studied, and defined as follows:

$${γ}_{i} ( h ) = \frac{1}{2} E ⌊ {( {I}_{i} ( z + h ) - {I}_{i} ( z ) )}^{2} ⌋$$

conditioning points that impose, if need be, the lithology to be simulated at certain depth points z.

Simulation is performed sequentially, that is the lithologies assigned to the various depths z are simulated by as many successive random selections by lots according to the following procedure:
random selection by lot of a depth z to be simulated in the lithologic column,
kriging of each indicatrix Iᵢ(z) at depth point z knowing the nature of the lithofacies at n conditioning points or depth points already simulated in the neighbourhood of z. This kriging allows estimation of the quantity Iᵢ*(z) associated with the lithofacies Lᵢ considered;
normalization of coefficients Iᵢ*(z) to all range between 0 and 1, and that their sum is 1. The estimated coefficients are then comparable to occurrence probabilities of the various lithologies;
construction of the cumulative histogram of the presence of the various lithofacies at depth z;
simulation of the lithofacies at depth z by Monte-Carlo drawing in the cumulative histogram: a random number is drawn in the uniform law between 0 and 1, and the interval in which this random number is contained determines the simulated lithofacies at depth point z; and
addition of the simulation result to the conditioning data and reiteration of the loop until exhaustion of the depth points to be simulated.

It is noted that the lithologic column thus obtained meets the properties of the well(s) studied, in terms of lithofacies proportions as well as vertical variability (variogram).

Simulation of a Porosity □ log

There are many methods for simulating a quantitative property in a conditioned way to a lithology. Four methods only are mentioned by way of example:
constant property by lithofacies

The value of the property studied is constant and fixed by lithofacies from well data. This value can be the average value of the property for a given lithofacies in one or more wells.
selection by lots in the experimental distribution function

The well data allow calculation of the experimental distribution function F(φ/Lᵢ) of the property selected for lithofacies Lᵢ. At depth point z, where lithofacies Lᵢ was simulated. A random number u is drawn on a uniform law between 0 and 1. The value of the simulated property φ is then such that: φ=F⁻¹(u).
selection by drawing lots in the normal distribution function

The method is identical to the selection by lots in the experimental distribution function, except that one imposes on F to be a normal law of average mᵢ and of standard deviation σᵢ calculated by means of the well data.
Gaussian sequential cosimulation

This method is more complex to implement because it involves determination of a co-regionalization model between the porosity and all of the indicatrix functions, a model that is in most cases impossible to determine from the well data only.

Results

Thus, from the logs obtained from the geological data and by means of indicatrix sequential simulations (pseudo-well method), simulated geological logs are generated which are referred to as pseudologs, corresponding to equally probable realizations of logs relative to geological properties. There are two types of pseudologs:
the pseudologs necessary for seismic attribute calculations, and
the pseudologs of lithologic facies.

3—Construction of a Seismic Constraint for the Geological Model (SC)

The seismic constraint used by the method according to the invention is a lithologic facies average proportion cube estimated from a seismic facies cube. The average proportions of lithologic facies and seismic facies are first determined. Then, the lithologic facies proportion distribution is estimated, thus allowing construction of a lithologic facies average proportion cube.

Measures and Simulated Logs Processing

This processing allows determination at the level of the wells and of the simulated wells (“pseudo-wells”) the average proportions of lithologic facies and of the seismic facies. Five stages are therefore carried out for each well and each simulated well:
a) Calculation of attributes from the logs necessary for seismic attribute calculation
The attributes used before for analysis of the seismic facies of the seismic data are also calculated at the level of all the wells (including the simulated wells). Within the context of the example, the measured logs and the simulated logs relative to density and the sonic log are used to determine the following attributes: P and S seismic impedances.
b) Depth/time conversion of the logs and of the proportion curves
All the logs are then converted into the time domain, using the time-depth conversion law available at the level of the corresponding well, then they are resampled at a very fine time interval to prevent spectral aliasing phenomena upon filtering.
c) Determination of a lithologic facies proportion curve
A lithologic facies vertical proportion curve is calculated from all the lithologic facies logs by evaluating the frequency of appearance of the various facies in a sliding time window, whose size corresponds to the vertical resolution of the seismic data. A lithologic facies proportion value is thus obtained for each time interval.
d) Resampling the logs and the curves at the seismic data interval
By construction, the vertical proportion curves of lithologic facies are at the time interval of the seismic data. Concerning the other logs (impedances for example), a low-pass frequency filter is applied in order to eliminate the high frequencies, not present in the seismic information, prior to carrying out resampling of all of the logs at the seismic time interval.
e) Determination of a seismic facies log from the classification function
Finally, the classification function determined upon the seismic facies analysis of the seismic data is used to interpret all the logs (measured and simulated) in terms of seismic facies. Realizations are thus obtained of seismic facies pseudologs, as well as seismic facies logs.

Construction of a lithologic facies average proportion cube

Let:
FSᵢ the seismic facies i
FLᵢ the lithologic facies j
prop(FLⱼ) the proportion of the lithologic facies j
P(prop(FLⱼ)) the distribution of the proportion of the lithologic facies j
P(prop(FLⱼ)/FSᵢ) the conditional distribution of the proportions of lithologic facies j for seismic facies i.
P(FSᵢ)

In the latter stage, the conditional distributions of the proportions of lithologic facies by seismic facies are estimated from measured and simulated logs. For example, for a seismic facies FS, the value of the proportion of lithologic facies FLⱼ is recorded in all the logs (measured and simulated). Deduced therefrom is the distribution of the value of the proportion of facies FLⱼ for facies FSᵢ:

P(prop(FLⱼ)/FSᵢ)

This is repeated for all the lithologic facies within seismic facies FSᵢ, and it is repeated again for all of the seismic facies.

Because of the large number of available data, due to the log simulation, in this estimation additional non-stationarity factors (depth, shaliness, . . . ) can be taken into account. Thus, the distributions can be characterized P(prop(FLⱼ)/FSᵢ,z,Vclay . . . ) that are more likely to be spatially stationary than the global distributions P(prop(FLⱼ)/FSᵢ).

By combining the seismic facies cube, the seismic facies classification probability cube P(FSᵢ) (from the seismic facies analysis) and the conditional distributions P(prop(FLⱼ)/FSᵢ) calculated before, a lithologic facies proportion distribution cube P(prop(FLⱼ)) is estimated.

This last stage is based on the total probabilities axiom:

$$P ( prop ( {FL}_{j} ) ) = {\sum }_{i} P ( prop ( {FL}_{j} ) / {FS}_{i} ) P ( {FS}_{i} )$$

At this stage, at each point of the subsoil there is a lithologic facies proportion distribution. From each local distribution the average that will constitute the seismic constraint necessary for geological modelling as described in the aforementioned document by Doligez et al. (2002) can be extracted. However, having a sufficient amount of data to extract reliable statistical parameters of these distributions, the method according to the invention also allows estimation of the uncertainty on each local proportion of each lithologic facies, by calculating from these distributions a standard deviation, an interquartile interval or an interval of confidence on the average.

4—Construction of the Geological Model Constrained by the Seismic Constraint (GM)

The seismic constraint thus estimated comes in a form of three-dimensional volumes of average proportions of each lithologic facies, that at each point of the subsoil there are average probabilities of encountering the various instances of each lithologic facies. This information then constrains the stochastic geological modelling process, which allows providing equally probable subsoil models by means of a random drawing process: at each point of the subsoil, the relative frequency of occurrence of the different lithologic facies calculated from the various realizations of the subsoil model will be equal to the average probability of the facies, deduced from the seismic data.

A geological model is thus constructed wherein the associated 3D maps of geological properties are constrained by the lithologic facies average proportion cube, deduced from the seismic data.

Validation of the Method: Case Study

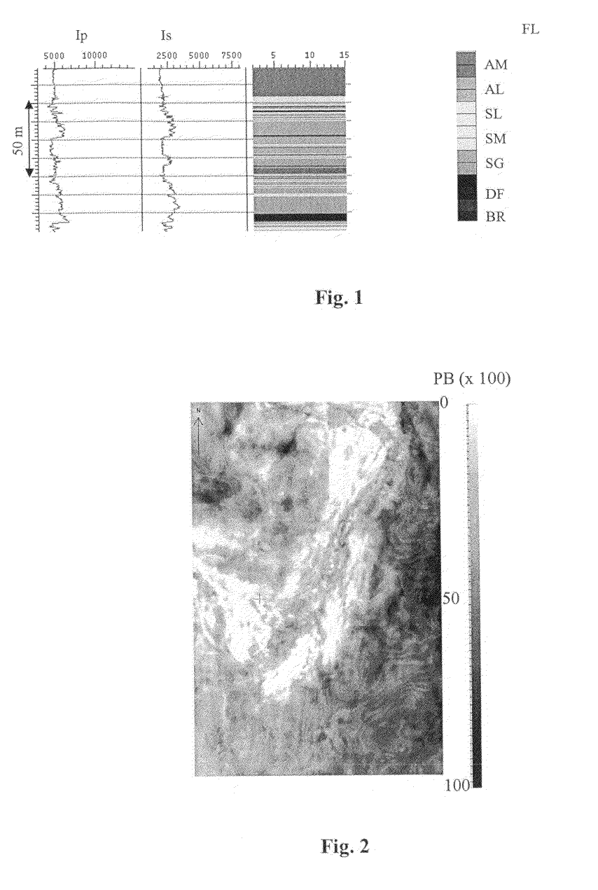

The application of the method according to the invention is illustrated with a real example where it is attempted to define a seismic constraint in form of average proportion volumes of lithologic facies by integrating the well information where the lithologic facies and the seismic information are defined. FIG. 1 shows the logging data available at the level of a well: geological facies interpretation (right), P and S impedance logs (left and center). The following nomenclature is used for the lithologic facies (FL): AM (massive clays), AL (laminated clays), SL (laminated sands), SM (massive sands), SG (coarse sands), DF (debris flows), BR (breaches). FIG. 2 shows the seismic information in form of a map from a 3D volume including probabilities of a particular seismic facies (massive clay-AM). This map is extracted from the cube along a reservoir level. The low-probability zones of this seismic facies allows identification of the reservoir formations likely to contain hydrocarbons.

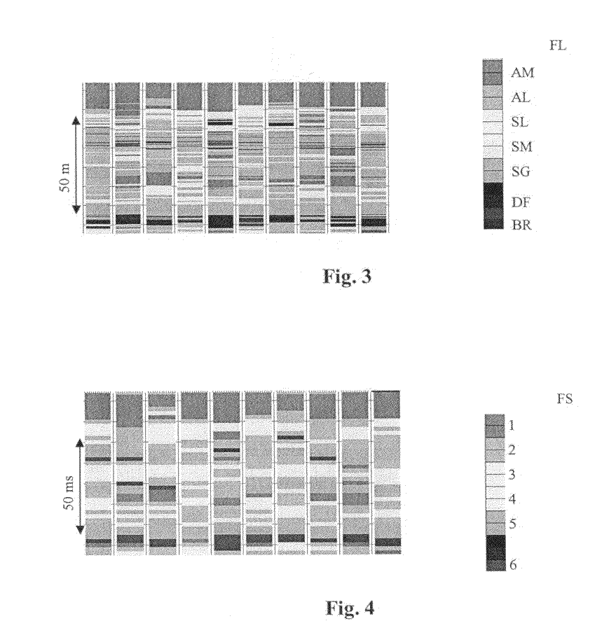

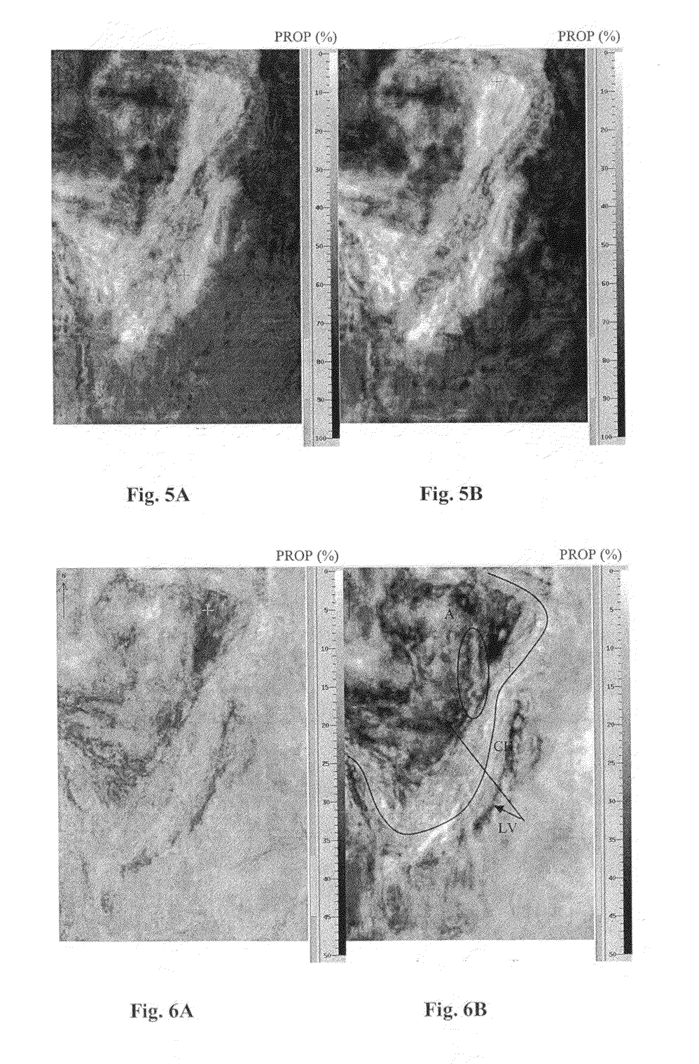

A prior crossed analysis of the seismic information and of the geological information shows in this case that the relation between seismic facies and lithologic facies is not stationary, the main factor influencing this non-stationarity being depth. According to the invention, pseudo-wells are generated comprising lithologic facies and P and S impedance data (which are the attributes used to generate the seismic facies interpretation of FIG. 2). FIG. 3 shows ten particular lithologic facies realizations (FL), corresponding to the well of FIG. 1. It can be observed that the simulated lithologic columns have a similar spatial variability: the sand reservoir levels are generally generated at similar depths. The vertical succession of the lithologic facies is also close to what is obtained in FIG. 1. After converting the P and S impedance simulations associated with these lithologic facies columns to impedance pseudologs whose sampling and vertical resolution are similar to the seismic data, the classification function used to generate the interpretation of FIG. 2 is applied thereto. FIG. 4 shows the ten most probable seismic facies (FS) columns corresponding to the ten lithologic facies (FL) columns of FIG. 3. The simulation process is continued until 5000 pseudo-well realizations are generated (500 simulations per well*10 wells), which is assumed to be sufficient to reliably evaluate the conditional distributions of lithologic facies proportions by seismic facies. The lithologic facies average proportions are then calculated by comparing the seismic facies simulations (FIG. 4) and the geological facies vertical proportion curves. These average proportions furthermore account for the dependence with depth: therefore the definition of the geological markers located in each well is used to isolate intervals in depth, the average proportions of lithologic facies by seismic facies being then calculated independently of one another in each interval. FIGS. 5A and 5B show the final result in terms of massive clay average proportions (PROP), calculated by combining the seismic facies probability maps such as the one in FIG. 2, and the lithologic facies distributions by seismic facies calculated before. FIGS. 5A and 5B show the average proportion maps of massive clays extracted at the level of the reservoir mentioned in FIG. 1. In FIG. 5A, these proportions were obtained without the method according to the invention: only the initial well data were taken into account (which precludes from taking account of the vertical non-stationarity). In FIG. 5B, these proportions were obtained by means of the method according to the invention: the simulation result and the vertical non-stationarity of the distributions were taken into account. The zones of low average proportion in white are more precisely defined in FIG. 5B.

FIGS. 6A and 6B show the same type of results for laminated clays (AL). In FIG. 6A, these proportions were obtained without the method according to the invention whereas in FIG. 6B, these proportions were obtained by means of the method according to the invention. The zones of higher average proportions are much more difficult to identify in FIG. 6A. On the contrary, in FIG. 6B, they are better defined: the laminated clays (AL) appear in a significant way alongside a North/South oriented channel (CH). This is compatible with the presence of levees (LV). By comparison, it can be seen in FIG. 6A that, if the vertical non-stationarity is not taken into account, the average proportion of this “laminated clays” (AL) facies in the same zone is greatly underestimated. The details that appear as a secondary channel (zone A) can also be noted.

The method according to the invention allows estimation at any point of the subsoil lithologic facies distributions that take fully advantage of the seismic information and of its spatial non-stationarities. The average of these distributions being more robust and better calibrated, it then allows better geological modelling and, consequently, better development of the petroleum reservoir corresponding to the geological model. The method according to the invention also allows estimation of the uncertainties on this seismic constraint. Potentially, it allows better integration of the seismic information in the geological modelling.

1-11. (canceled)

12. A method of constructing a geological model of a subsoil formation constrained by seismic data, from logs relative to geological properties of the subsoil acquired in at least one well drilled through the subsoil, and wherein at least one seismic facies cube is constructed, comprising:
generating simulated geological logs corresponding to equally probable realizations of logs relative to geological properties, by carrying out an indicatrix sequential simulation from the logs acquired in the well;
generating simulated seismic facies logs corresponding to equally probable realizations of logs relative to the seismic facies, by interpreting the simulated geological logs;
constructing a lithologic facies proportion distribution cube comprising voxels with each voxel containing distributions of proportions of each facies by using the logs acquired in the at least one well, the simulated geological logs and the seismic facies cube;
constructing a lithologic facies average proportion cube comprising voxels with each voxel containing an estimation of a proportion of each lithographic facies contained in the voxel by extracting an average of a lithological facies proportion distribution at each voxel of the lithologic facies proportion distribution cube;
constructing a geological model wherein the geological properties are constrained by the lithologic facies average proportion distribution cube.

13. A method as claimed in claim 12, wherein the simulated seismic facies logs are generated by means of a relation between the seismic data and the seismic facies of the lithologic facies average proportion cube, the relation being obtained by a seismic facies analysis.

14. A method as claimed in claim 12, wherein estimation of the lithologic facies average proportions comprises:
estimating conditional distributions of lithologic facies proportions by seismic facies from the logs acquired in the at least one well and the simulated geological and seismic facies logs;
determining classification probabilities for the seismic facies, and a relation between the seismic data and the seismic facies, by means of a seismic facies analysis; and
estimating at any point of the subsoil the lithologic facies proportions at any voxel, by combining the conditional distributions on the classification probabilities.

15. A method as claimed in claim 13, wherein estimation of the lithologic facies average proportions comprises:
estimating conditional distributions of lithologic facies proportions by seismic facies from the logs acquired in the at least one well and the simulated geological and seismic facies logs;
determining classification probabilities for the seismic facies, and a relation between the seismic data and the seismic facies, by means of a seismic facies analysis; and
estimating at any point of the subsoil the lithologic facies proportions at any voxel, by combining the conditional distributions on the classification probabilities.

16. A method as claimed in claim 12, wherein the simulated geological logs comprise at least one of the following logs: a lithologic facies log, a P wave impedance log and a S wave impedance log.

17. A method as claimed in claim 13, wherein the simulated geological logs comprise at least one of the following logs: a lithologic facies log, a P wave impedance log and a S wave impedance log.

18. A method as claimed in claim 14, wherein the simulated geological logs comprise at least one of the following logs: a lithologic facies log, a P wave impedance log and a S wave impedance log.

19. A method as claimed in claim 15, wherein the simulated geological logs comprise at least one of the following logs: a lithologic facies log, a P wave impedance log and a S wave impedance log.

20. A method as claimed in claim 12, wherein the simulated logs are generated in depth, then converted into time by means of a predetermined time-depth conversion law at a level of the well.

21. A method as claimed in claim 20, wherein the simulated logs converted into time are resampled at the seismic data interval.

22. A method as claimed in claim 16, wherein the simulated logs relative to lithologic facies are resampled by determining a vertical proportion curve, by evaluating a frequency of appearance of the lithologic facies in a sliding time window with size corresponding to the vertical resolution of the seismic data.

23. A method as claimed in claim 16, wherein the simulated logs which are not relative to lithologic facies, are resampled with a low-pass frequency filter in order to eliminate high frequencies that are not present in the seismic data.

24. A method as claimed in claim 12, wherein estimation of distribution of the lithologic facies proportion comprises using non-stationarity factors.

25. A method as claimed in claim 20 wherein the factors include at least one of depth or shaliness.

26. A method as claimed in claim 12, wherein an uncertainty on distribution of the lithologic facies proportions at any point of the subsoil is estimated.

27. A method as claimed in claim 26, wherein the uncertainty is estimated by calculating at least one statistical parameters as follows: a standard deviation of the distributions, an interquartile interval of the distributions, or a confidence interval on a distribution average.
